(19) United States
(12) Patent Application Publication
(10) Pub. No.: US 2013/0211909 A1
(43) Pub. Date: Aug. 15, 2013

(54) SERVER DEVICE AND ADVERTISMENT IMAGE DISTRIBUTION AND PROGRAM

(71) Applicants: Yuzuru Tanaka, Shibuya-ku (JP); Rei Hiramatsu, Shibuya-ku (JP); Minoru Matsushima, Shibuya-ku (JP); Junko Yamada, Shibuya-ku (JP); Yu Higashiyama, Shibuya-ku (JP); Kazuhiro Mitsuhashi, Shibuya-ku (JP); Hibiki Takama, Shibuya-ku (JP)

(72) Inventors: Yuzuru Tanaka, Shibuya-ku (JP); Rei Hiramatsu, Shibuya-ku (JP); Minoru Matsushima, Shibuya-ku (JP); Junko Yamada, Shibuya-ku (JP); Yu Higashiyama, Shibuya-ku (JP); Kazuhiro Mitsuhashi, Shibuya-ku (JP); Hibiki Takama, Shibuya-ku (JP)

(73) Assignee: FRINGE81, INC., Tokyo (JP)

(21) Appl. No.: 13/580,424

(22) PCT Filed: Feb. 24, 2011
(86) PCT No.: PCT/JP2011/054144

§ 371 Date: Mar. 28, 2013

(30) Foreign Application Priority Data
Feb. 25, 2010 (JP) 2010041066

(51) Int. Cl. G06Q 30/02

(52) U.S. Cl. CPC G06Q 30/0246
USPC 705/14.45

(57) ABSTRACT

To provide a technique for maintaining high efficiency of advertisement images. In response to a request for a banner advertisement data set from a terminal device, a second banner distribution server device selects a banner advertisement data set at distribution frequencies that are determined in advance, and distributes the selected banner advertisement data set to the terminal device. For the first distribution term, the second banner distribution server device determines distribution frequencies so that each attribute of each component comprising a banner advertisement image is contained in distributed banner advertisement images at an equal rate. In the second and later distribution terms, banner advertisement data sets that had CTRs equal to or greater than a baseline-CTR in the previous distribution term are continuously distributed.

### TECHNICAL FIELD

This invention relates to a technique for distributing advertisement images such as banner advertisements via networks such as the Internet.

### BACKGROUND

Many web pages are used as advertisement media. Namely, many web pages contain advertisement images, and viewers of the web pages can see the advertisement images and are thus encouraged to take an interest in the advertised products or services.

Most advertisement images contained in web pages are linked to URLs (Uniform Resource Locators) of other web pages indicating detailed information of goods or services to be advertised as link data sets. When a viewer performs a particular operation such as clicking on an advertisement image linked to a URL, a web page identified by the URL is displayed on the viewer's terminal device. (In the following explanation, the particular operation made by a viewer to display a web page linked to an advertisement image is assumed to be a click.)

CTRs (Click Through Rates) and CVRs (Conversion Rates) are indexes popularly used for indicating advertising efficiency achieved by advertisement images contained in web pages. A CTR is a ratio of a number of clicks made on an advertisement image to a number of impressions, i.e. a number of times the advertisement image is displayed. A CVR is a ratio of a number of times of execution of a particular process such as display of a web page for ordering goods or services, to a number of times of display of the web page indicating detailed information that is linked to the clicked advertisement image.

A method having a step for distributing plural advertisement images, on a trial basis, that advertise the same goods or services but have different appearances from one another, and a step for distributing those advertisement images that win high scores of CTR or CVR in the step for distributing advertisement images during the trial, for the purpose of increasing efficiency of the advertisement, is known. For example, JP2008-502079 proposes a method for determining an appearance of an advertisement image that can be expected to bring a high advertising efficiency by selecting some attributes that are believed to be influential to advertising efficiency from among attributes of components of advertisement images distributed on a trial basis.

### SUMMARY OF INVENTION

[Advertising efficiency of an advertisement image may change continuously. As an example, advertising efficiency of an advertisement image normally decreases as time passes since the same advertisement image becomes familiar to viewers even if the advertisement image has a high advertising efficiency at the beginning of distribution. As another example, when seasons change, appearances of advertisement images that attract the interest of viewers may change.

In consideration of the above situation, the object of the invention is to provide an advertiser with a technique for maintaining high advertising efficiency of advertisement images.

To solve the above-mentioned problems, the present invention provides, as a first embodiment, a server device comprising: a generating unit that selects, in connection with each of plural components of an advertisement image, one attribute from among plural candidate attributes of the component in accordance with a predetermined rule, and generates an image data set indicating an advertisement image composed of plural components each of which has the selected attribute; a receiving unit that receives a request for an image data set from any terminal device; a transmitting unit that transmits an image data set generated by the generating unit in response to the request; and a timing unit; wherein the receiving unit receives a notice of display that indicates which image data set among plural image data sets generated by the generating unit and transmitted by the transmitting unit was used for displaying an advertisement image at any terminal device; the receiving unit receives a notice of advertisement operation that indicates which image data set among plural image data sets generated by the generating unit and transmitted by the transmitting unit was used for displaying an advertisement data set on which a particular operation was performed by a user of the terminal device; the service device further comprises: a determining unit that repeatedly determines as time passes, in connection with each of plural image data sets indicating advertisement images that are different from each other, a frequency of transmission of the image data set transmitted to terminal devices by the transmitting unit during a predetermined period in the future, based on a number of display times that indicates a number of times of display of an advertisement image made by terminal devices using the image data set during a predetermined period in the past, the number of display times being determined by counting notices of display received by the receiving unit in the predetermined period in the past, and based on a number of advertisement operation times that indicates a total number of times a particular operation is performed by users of terminal devices on advertisement images indicated by the image data set during the predetermined period in the past, the number of advertisement operation times being determined by counting notices of advertisement operation received by the receiving unit in the predetermined period in the past.

The present invention also provides, as a second embodiment, a server device of the first embodiment, wherein: the determining unit calculates, in connection with each of plural image data sets including image data sets that can be generated by the generating unit and that were not transmitted by the transmitting unit in a predetermined period in the past, an estimated ratio of a number of times of the particular operation performed on advertisement images indicated by the image data set at terminal devices to a number of times of display of advertisement images made at terminal devices using the image data set, based on the number of display times and the number of advertisement operation times, and determines a frequency of transmission in connection with the image data set based on the estimated ratio calculated in connection with the image data set.

The present invention also provides, as a third embodiment, a server device of the second embodiment, wherein: the determining unit determines, in connection with each of plural components that may compose an advertisement image, a number of component display times that indicates a number of times of display of advertisement images composed of the component at terminal devices based on notices of display received by the receiving unit; the determining unit determines, in connection with each of plural components that may compose an advertisement image, a number of component operation times that indicates a number of times the particular operation was performed by users of arbitrary terminal devices on advertisement images composed of the component at terminal devices based on notices of advertisement operation received by the receiving unit; and the determining unit calculates the estimated ratio by conducting multivariate analysis in which the numbers of component display times determined in connection with the plural components and the numbers of component operation times determined in connection with the plural components are used as explanatory variables.

The present invention also provides, as a fourth embodiment, a server device of any one of the first to the third embodiments, wherein: the number of display times in connection with each of the plural image data sets indicates, in connection with each of plural time zones, a number of times of display of advertisement images indicated by the image data set at terminal devices in the time zone; the number of advertisement operation times in connection with each of the plural image data sets indicates, in connection with each of the plural time zones, a number of times the particular operation was performed by users of arbitrary terminal devices on advertisement images indicated by the image data set in the time zone; and the determining unit determines, in connection with each of combinations of the plural image data sets and the plural time zones, a frequency of transmission of the image data set to terminal devices in the time zone.

The present invention also provides, as a fifth embodiment, a server device of any one of the first to the fourth embodiments, wherein: the display number of times in connection with each of the plural image data sets indicates, in connection with each of plural areas, a number of times of display of advertisement images indicated by the image data set at terminal devices in the area; the number of advertisement operation times in connection with each of the plural image data sets indicates, in connection with each of the plural areas, a number of times the particular operation was performed by users of terminal devices on advertisement images indicated by the image data set in the area; the receiving unit receives an area data set that indicates an area where a terminal device from which the request is transmitted is located; and the determining unit determines, in connection with each of combinations of the plural image data sets and the plural areas, a frequency of transmission of the image data set to terminal devices in the area.

The present invention also provides, as a sixth embodiment, a server device of any one of the first to the fifth embodiments, wherein: the number of display times in connection with each of the plural image data sets indicates, in connection with each of plural display attributes that a terminal device may have, a number of times of display of advertisement images indicated by the image data set at terminal devices that have the display attribute; the number of advertisement operation times in connection with each of the plural image data sets indicates, in connection with each of the plural display attributes, a total number of times that the particular operation was performed by users of arbitrary terminal devices that have the display attribute; the receiving unit receives a display attribute data set that indicates a display attribute that a terminal device from which the request is transmitted has; and the determining unit determines, in connection with each of combinations of the plural image data sets and the plural display attributes, a frequency of transmission of the image data set to terminal devices that have the display attribute.

The present invention also provides, as a seventh embodiment, a server device of any one of the first to the sixth embodiments, wherein: the number of display times in connection with each of the plural image data sets indicates, in connection with each of plural user attributes that a user of a terminal device may have, a number of times of display of advertisement images indicated by the image data set at terminal devices used by users who have the user attribute; the number of advertisement operation times in connection with each of the plural image data sets indicates, in connection with each of the plural user attributes, a number of times the particular operation was performed by users of terminal devices who have the user attribute; the receiving unit receives a user attribute data set that indicates a user attribute that a user of a terminal device from which the request is transmitted has; and the determining unit determines, in connection with each of combinations of the plural image data sets and the plural user attributes, a frequency of transmission of the image data set to terminal devices used by users who have the user attribute.

The present invention also provides, as an eighth embodiment, a server device of any one of the first to the seventh embodiments, wherein: the generating unit generates image data sets that are to be transmitted by the transmitting unit in response to a request for an image data set received by the receiving unit at a frequency determined by the determining unit

The present invention also provides, as a ninth embodiment, a server device of any one of the first to the eighth embodiments further comprising: a first server device and a second server device that can communicate with each other via one or more networks; wherein the function of receiving a request for an image data set from an arbitrary terminal device of the receiving unit is allocated to the first server device; and the functions of the determining unit are allocated to the second server device.

The present invention also provides, as a tenth embodiment, a server device of any one of the first to the ninth embodiments, wherein: the receiving unit receives a notice of page operation that indicates that a particular operation was performed by a user of an arbitrary terminal device on a web page displayed at the terminal device, the web page being displayed in accordance with a web page data set that the terminal device received from a web server device via a connection established between the server device and the terminal device, the web server transmitting the web page data set to the terminal device in response to a particular operation performed on an advertisement image displayed at the terminal device, the web page data set giving instructions to display the web page; and the determining unit determines, in connection with each of plural image data sets that indicate advertisement images different from each other, the frequency at which the image data set should be transmitted to terminal devices by the transmitting unit in a predetermined period in the future, based on number of a page operation times that indicates a number of times a particular operation was performed by users of terminal devices on a web page linked to an advertisement image indicated by the image data set during a predetermined period in the past, the number of page operation times being determined by counting notices of page operation received by the receiving unit in the predetermined period in the past.

The present invention also provides, as an eleventh embodiment, a server device of the tenth embodiment, wherein: the determining unit determines the frequency so that a ratio of a sum of frequencies determined based on the number of display times and the number of advertisement operation times to a sum of frequencies determined based on the number of page operation times becomes a predetermined ratio.

The present invention also provides, as a twelfth embodiment, a server device of any one of the ninth and the tenth embodiments, wherein: the number of page operation times indicates, in connection with each of plural types of operations, a number of times the type of operation was performed by users of terminal devices; and the determining unit determines the frequency so that a ratio of a sum of frequencies determined based on the number of times one of the plural types of operations was performed to a sum of frequencies determined based on the number of times another of the plural sorts of operations was performed becomes a predetermined ratio.

The present invention also provides, as a thirteenth embodiment, a program that instructs a computer having a communicating unit that communicates with a terminal device and a timing unit to function as the generating unit, the receiving unit, the transmitting unit and the determining unit that compose a server device of any one of the first to the twelfth embodiments.

In the server device of the first embodiment of the present invention, frequency of distribution each of plural advertisement images that will be distributed during a predetermined period in the future is repeatedly determined based on advertising efficiency of each of plural advertisement images that were distributed during a corresponding predetermined period in the past, and advertisement images to be distributed at the determined frequencies are automatically generated. Accordingly, advertisement images that bring high advertising efficiency are distributed continuously and with less delay and at lower cost than, for example, in a system where each of advertisement images for distribution is manually designed and evaluated by a designer.

In the server device of the second embodiment of the present invention, advertising efficiency of advertisement images that have not been distributed yet is estimated, and advertisement images that are to be distributed in the predetermined period in the future are determined based on the estimated advertising efficiency. Accordingly, for example, certain advertisement images that were not distributed since they were judged to bring low advertising efficiency in the past may be distributed if they are anticipated to bring high advertising efficiency in the present. As a result, advertising efficiency achieved by distribution of advertisement images as a whole is increased.

In the server device of the third embodiment of the present invention, advertising efficiency of images is estimated by use of multivariable analysis. Accordingly, advertisement images that are statistically proved to bring high advertising efficiency are distributed.

In the server device of the fourth embodiment of the present invention, in each of different time zones, each of advertisement images is distributed at a frequency corresponding to the current time zone. Accordingly, even if advertising efficiency of an advertisement image changes in accordance with a time zone, advertisement images that bring high advertising efficiency are continuously distributed.

In the server device of the fifth embodiment of the present invention, in each of different areas where terminal devices used by visitors are located, each of advertisement images is distributed at a frequency corresponding to the area where a terminal device that displays the advertisement image is currently located. Accordingly, even if advertising efficiency of an advertisement image changes in accordance with area, advertisement images that bring high advertising efficiency are continuously distributed.

In the server device of the sixth embodiment of the present invention, each of advertisement images is distributed at a frequency corresponding to display attributes of terminal devices used by visitors such as width of display, number of pixels, background color of browser, whether the terminal device is a mobile device or not, etc. Accordingly, even if advertising efficiency of an advertisement image changes in accordance with display attributes, advertisement images that bring high advertising efficiency are continuously distributed.

In the server device of the seventh embodiment of the present invention, each of advertisement images is distributed at a frequency corresponding to user attributes of visitors such as gender, age group, tastes, etc. Accordingly, even if advertising efficiency of an advertisement image changes in accordance with user attributes, advertisement images that bring high advertising efficiency are continuously distributed.

In the server device of the eighth embodiment of the present invention, after a request for an advertisement image is received, an advertisement image is generated in response to the request. Accordingly, advertisement images contain a same type of component but indicate information that changes as time passes, such as a sales copy indicating a remaining time until a deadline, a sales copy indicating a number of remaining goods, etc., and thus advertising efficiency is increased.

In the server device of the ninth embodiment of the present invention, the server according to the present invention is composed of plural server devices. Accordingly, for example, the above explained effects of the present invention are achieved as a result of communication between a new server device that determines frequencies of distribution of advertisement images communicate and an existing server device that distributes advertisement images via a network without any substantial change being made to the existing server.

In the server device of the tenth embodiment of the present invention, frequencies of distribution of advertisement images to be distributed in a predetermined period in the future are determined based on information such as CV (Conversion), CVR, and number of stays. Accordingly, compared to the case where frequencies of distribution of advertisement images are determined, for example, based on only CTR, a higher advertising efficiency can be achieved.

In the server device of the eleventh embodiment of the present invention, a ratio between a sum of frequencies of distribution determined based on CTR and a sum of frequencies of distribution determined based on indexes depending on operations performed on web pages displayed in response to certain operations to an advertisement image such as CV, CVR, and number of stays is adjusted so that advertising efficiency is increased.

In the server device of the twelfth embodiment of the present invention, a ratio between frequencies of distribution determined based on one type of operation and another type of operation, such as CV, CVR, and number of stays, performed on web pages displayed in response to particular operations performed on an advertisement image is adjusted so that advertising efficiency is increased.

According to a program of the thirteenth embodiment of the present invention, the above explained effects of the present invention are achieved by use of a computer.

### BRIEF DESCRIPTION OF DRAWINGS

FIG. 1 illustrates an entire constitution of a banner distribution system according to an exemplary embodiment of the present invention.

FIG. 2 illustrates a functional constitution of a second banner distribution server device according to the exemplary embodiment of the present invention.

FIG. 3 illustrates a data structure of a list of component attributes according to the exemplary embodiment of the present invention.

FIG. 4 illustrates a data structure of log data sets according to the exemplary embodiment of the present invention.

FIG. 5 illustrates a flow of processes performed by the second banner distribution server device for determining frequencies of distribution of banner advertisements in the exemplary embodiment of the present invention.

FIG. 6 illustrates a sample of a list indicating frequencies of distribution of banner advertisements according to the exemplary embodiment of the present invention.

FIG. 7 illustrates a sample of a list indicating results of distribution of banner advertisements according to the exemplary embodiment of the present invention.

FIG. 8 illustrates samples of weights used in the exemplary embodiment of the present invention.

FIG. 9 illustrates a sample of a list indicating weights assigned to attributes of banner advertisements.

FIG. 10 illustrates samples of partial regression coefficients calculated in the exemplary embodiment of the present invention.

FIG. 11 illustrates a sample of a list indicating rankings of banner advertisements.

### DETAILED DESCRIPTION

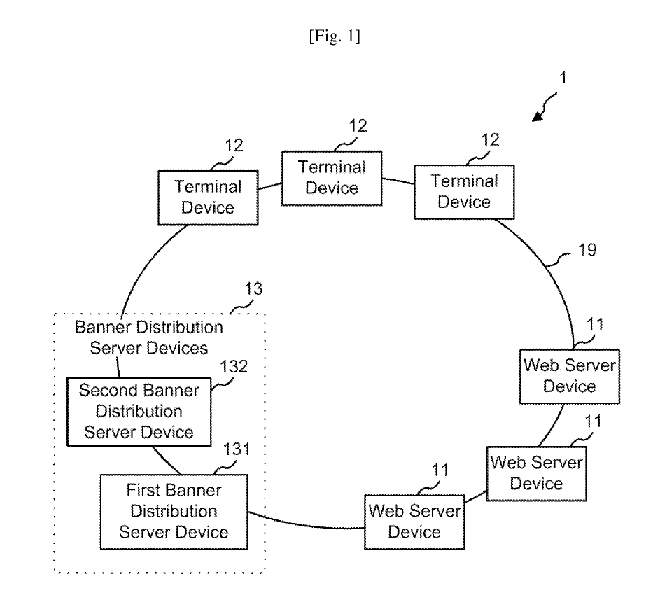

FIG. 1 illustrates an entire constitution of banner distribution system 1 according to an exemplary embodiment of the present invention. Banner distribution system 1 comprises an arbitrary number of web server devices 11, an arbitrary number of terminal devices 12, and banner distribution server devices 13. Web server devices 11 and terminal devices 12 can communicate with each other via Internet 19. Similarly, terminal devices 12 and banner distribution server devices 13 can communicate with each other via Internet 19, and banner distribution server devices 13 and web server devices 11 can communicate with each other via Internet 19.

Banner distribution server devices 13 contain first banner distribution server device 131 and second banner distribution server device 132. First banner distribution server device 131 and second banner distribution server device 132 can communicate with each other via Internet 19.

Web server device 11 is a commonly used web server device that transmits web page data sets to terminal devices 12 in response to requests for the web page data sets from terminal devices 12. A web page data set is described in a markup language such as HTML (HyperText Markup Language) and indicates contents displayed in a web page.

Web pages displayed at terminal devices 12 in accordance with web page data sets transmitted from web server devices 11 usually contain banner advertisements. In the following explanation, a banner advertisement means an advertisement image that is located in a web page and accompanied by a URL of another web page as a link data set. Usually, a web page linked to a banner advertisement provides visitors with detailed information on goods or services.

In the following explanation, it is assumed that banner advertisement data sets indicating banner advertisements do not accompany web page data sets transmitted from web server devices 11 to terminal devices 12, and they are obtained by terminal devices 12 from banner distribution server devices 13 in accordance with URLs described in web page data sets.

Terminal device 12 is a commonly used terminal device that has a function of browsing web pages. Terminal device 12 receives from web server devices 11 a web page data set identified by a URL input by a user of terminal device 12, obtains banner advertisement data sets in accordance with URLs of the banner advertisement data sets described in the received web page data set, and displays banner advertisements in accordance with the banner advertisement data sets in a web page that is displayed in accordance with the received web page data set.

A banner advertisement data set contains a URL of a dummy image data set as a link data set. The dummy image data set indicates a dummy image. The dummy image has, for example, a size of 1 pixel by 1 pixel, and it has no color. Accordingly, terminal device 12 never displays the dummy image. The dummy image enables a server device that transmits the dummy image data set to terminal devices 12 to recognize how many times in total a particular banner advertisement was displayed at terminal devices 12. When the particular banner advertisement is displayed at terminal device 12, a request for the dummy image data set is transmitted from terminal device 12 to a server device identified by a URL of the dummy image data set. The request contains, for example, a file name of the dummy image data set that identifies the displayed banner advertisement. The server device recognizes how many times the particular banner advertisement was displayed at terminal devices 12 by counting the requests. Namely, a request for a dummy image data set indicates that a particular banner advertisement was displayed at terminal device 12.

As will be explained in detail later, in banner distribution system 1, second banner distribution server device 132 transmits dummy data sets to terminal devices 12.

When a user of terminal device 12 clicks a banner advertisement, terminal device 12 receives from web server device 11 a web page data set corresponding to a URL linked to the banner advertisement, and displays a web page for providing detailed information of goods or servers (referred to as “detailed information page” hereinafter) in accordance with the received web page data set. Layout of the detailed information page and web pages linked to the detailed information page may vary depending on contents of the detailed information page. In the following explanation, it is assumed that the detailed information page contains a “Purchase” button, and when a user of terminal device 12 clicks the “Purchase” button, terminal device 12 transmits an order data set indicating an order of goods or services to web server device 11.

When a banner advertisement is clicked, a notice of click containing an identifier of the banner advertisement (referred to as “banner ID” hereinafter) is transmitted from terminal device 12 to second banner distribution server device 132. A notice of click is a data set indicating that a banner advertisement identified by a banner ID was clicked.

When “Purchase” button is clicked, a notice of order is transmitted form terminal device 12 to second banner distribution server device 132. A notice of order contains a banner ID of a banner advertisement that a user of terminal device 12 clicked for displaying the detailed information page. A notice of order is a data set indicating that an order of goods or services was made in a detailed information page that was displayed in response to a click on a banner advertisement identified by a banner ID contained in the notice.

First banner distribution server device 131 receives requests for banner advertisement data sets from terminal devices 12, and forwards the received requests for banner advertisement data sets to second banner distribution server device 132. First banner distribution server device 131 comprises, as functional components, a communication unit that has a receiving unit that receives requests for banner advertisement data sets from terminal devices 12 and a transmitting unit that transmits the requests for banner advertisement data sets received by the receiving unit to second banner distribution server device 132.

Second banner distribution server device 132 receives requests for banner advertisement data sets via first banner distribution server device 131 from terminal devices 12, and transmits banner advertisement data sets to terminal devices 12 in response to the requests for banner advertisement data sets. Banner distribution server devices 13 comprised of first banner distribution server device 131 and second banner distribution server device 132 function as normal banner distribution server devices.

Second banner distribution server device 132 receives requests for display, notices of click, and notices of order from terminal devices 12, and determines how frequently a particular banner advertisement data set should be distributed to terminal devices 12 in a certain period in the future, based on the received notices. Then, second banner distribution server device 132 generates banner advertisement data sets and transmits them to terminal devices 12 at the determined frequencies, in response to the received requests.

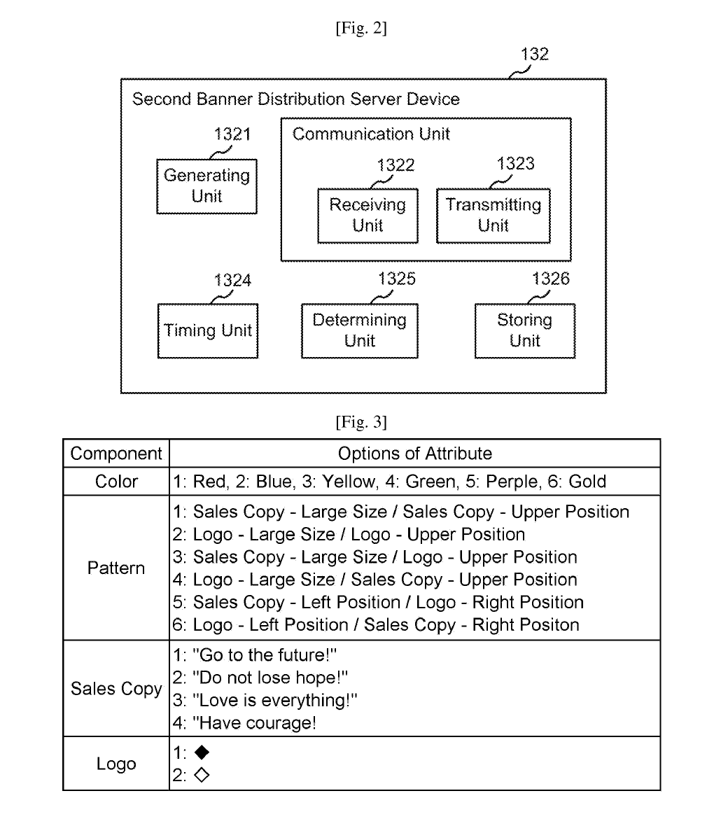

As illustrated in FIG. 2, second banner distribution server device 132 comprises, as functional components, generating unit 1321 that generates banner advertisement data sets indicating banner advertisement images with a number of variations in appearance, receiving unit 1322 that receives requests for banner advertisement data sets from first banner distribution server device 131 and notices of display, notices of click and notices of order from terminal devices 12, transmitting unit 1323 that transmits banner advertisement data sets to terminal devices 12 in response to requests for banner advertisement data sets, timing unit 1324 that generates time data sets indicating current times, determining unit 1325 that determines which banner advertisement data sets should be distributed to terminal devices 12 by transmitting unit 1323, and storing unit 1326 that stores various types of data sets and is used as working area. Receiving unit 1322 and transmitting unit 1323 compose a communication unit.

Generating unit 1321 selects, in connection with each of plural components that make up a banner advertisement image (referred to as simply “components” hereinafter), one attribute among from plural predetermined candidate attributes (referred to as “candidate attributes” hereinafter), and generates a banner advertisement data set indicating a banner advertisement image that is specified by a combination of the selected attributes, each of which corresponds to each of the plural components. FIG. 3 illustrates a data structure of a component attribute list that indicates components and attributes of each of the components. The component attribute list is stored in storing unit 1326.

The sample list shown in FIG. 3 indicates four components that compose a banner advertisement image, namely a first component “color,” a second component “pattern,” a third component “sales copy,” and a fourth component “logo.” Moreover, the sample list indicates that the first component “color” may have one attribute selected from among six candidate attributes identified by attribute IDs 1 to 6, the second component “pattern” may have one attribute selected from among six candidate attributes identified by attribute IDs 1 to 6, the third component “sales copy” may have one attribute selected from among four candidate attributes identified by attribute IDs 1 to 4, and the fourth component “logo” may have one attribute selected from among two candidate attributes identified by attribute IDs 1 and 2. Each of the attribute IDs identifies a specific candidate attribute. For example, according to the sample list shown in FIG. 3, attribute ID “1” of the first component “color” identifies “red,” and attribute ID “2” identifies “blue.”

In accordance with the sample list shown in FIG. 3, generating unit 1321 may generate banner advertisement images with 288 (6*6*4*2=288) variations in appearance.

Each of banner advertisement data sets generated by generating unit 1321 is identified by a banner ID expressed by an 8-digit natural number such as “23120023.” The first digit, the second digit, the third digit and the fourth digit of a banner ID indicate an attribute ID of the first component, an attribute ID of the second component, an attribute ID of the third component and an attribute ID of the fourth component, respectively. Namely, the first four digits of a banner ID identify an appearance of a banner advertisement image.

The latter four digits of a banner ID indicate what number of distribution group the banner advertisement data set belongs to. “Distribution group” means a group of banner advertisement data sets that are distributed in a certain period at frequencies determined by determining unit 1325. For example, when the last four digits of a banner ID are “0023,” the banner ID indicates that a banner advertisement data set identified by the banner ID is a banner advertisement data set that is distributed in the 23rd term of distribution at a frequency determined for the banner advertisement data set by determining unit 1325.

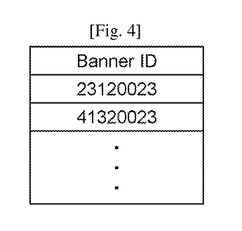

When there is no need to specify what number of distribution group a banner advertisement data set belongs to, only the first four digits of a banner ID are referred to. When receiving unit 1322 receives a notice of display, a notice of click or a notice of order, a banner ID contained in the notice is recorded in storing unit 1326 as a display log data set, a click log data set, and an order log data set respectively. Data structures of these log data sets are the same. FIG. 4 illustrates a sample of the data structure of the log data sets.

When banner IDs contained in display log data sets are counted by their first four digits, a number of times each of banner advertisement images with different appearances was displayed (referred to as “number of times of display” hereinafter) in all distribution terms in the past is specified. When banner IDs contained in clock log data sets are counted by their first four digits, a number of times each of banner advertisement images with different appearances was clicked (referred to as “number of times of click” hereinafter) in all distribution terms in the past is specified. When banner IDs contained in order log data sets are counted by their first four digits, a number of times orders were made in web pages directly or indirectly linked to each of banner advertisement images with different appearances (referred to as “number of times of order” hereinafter) in all distribution terms in the past is specified. When a number of times of click is divided by a number of times of display in connection with a banner advertisement image having a particular appearance, a CTR of the banner advertisement image is calculated. In the following explanation, a CTR in connection with all distribution terms in the past is referred to as “all-term-CTR.” When a number of times of order is divided by a number of times of click in connection with a banner advertisement image having a particular appearance, a CVR of the banner advertisement image is calculated. In the following explanation, a CVR in connection with all distribution terms in the past is referred to as “all-term-CVR.”

When banner IDs contained in display log data sets are counted by combinations of their first four digits and their last four digits, a number of times of display of each appearance of banner advertisement images in each distribution term in the past is specified. When banner IDs contained in click log data sets are counted by combinations of their first four digits and their last four digits, a number of times of click of each appearance of banner advertisement images in each distribution term in the past is specified. When banner IDs contained in order log data sets are counted by combinations of their first four digits and their last four digits, a number of times of order of each appearance of banner advertisement images in each distribution term in the past is specified. When a number of times of click in a particular distribution term is divided by a number of times of display in the particular distribution term, a CTR in the particular distribution term is calculated. In the following explanation, a CTR in connection with a particular distribution term is referred to as “term-CTR.” When a number of times of order in a particular distribution term is divided by a number of times of click in the particular distribution term, a CVR in the particular distribution term is calculated. In the following explanation, a CVR in connection with a particular distribution term is referred to as “term-CVR.”

The above explained all-term-CTR, all-term-CVR, term-CTR and term-CVR are calculated by determining unit 1325, and used for specifying frequencies at which each of banner advertisement images having a different appearance should be distributed (referred to as “distribution frequency” hereinafter). A distribution frequency of a banner advertisement image means a ratio of a number of distributions of the banner advertisement image in a distribution term to a number of distributions of all banner advertisement data sets in the distribution term.

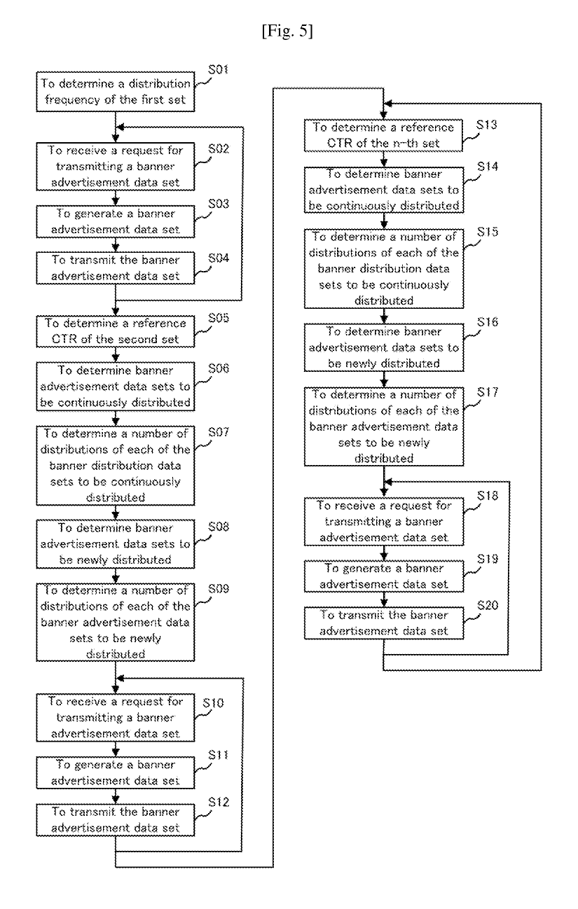

Determining unit 1325 estimates indexes of advertising efficiency such as CTR in connection with each of all appearances of banner advertisement images at the current moment based on indexes related to all distribution terms in the past, such as all-term-CTR and all-term-CVR, and based on the indexes related to the most recent distribution term in the past, such as term-CTR of the most recent distribution term and term-CVR of the most recent distribution term. The estimated indexes contain indexes related to appearances of banner advertisement images that were not distributed in the most recent distribution term, as well as indexes related to appearances of banner advertisement images that were distributed in the most recent distribution term. Determining unit 1325 determines distribution frequencies of banner advertisement images in a future distribution term based on the estimated indexes. Now, an example of a flow of processes performed by determining unit 1325 for determining distribution frequencies illustrated in FIG. 5 will be explained. In the example illustrated in FIG. 5, CTRs are used for determining distribution frequencies.

For determining distribution frequencies of the first distribution term, first, determining unit 1325 selects appearances of banner advertisements in a random manner under the conditions that distribution frequencies in connection with each attribute of each component are equal to each other, and determines distribution frequencies of the selected appearances so that all distribution frequencies are the same (step S01).

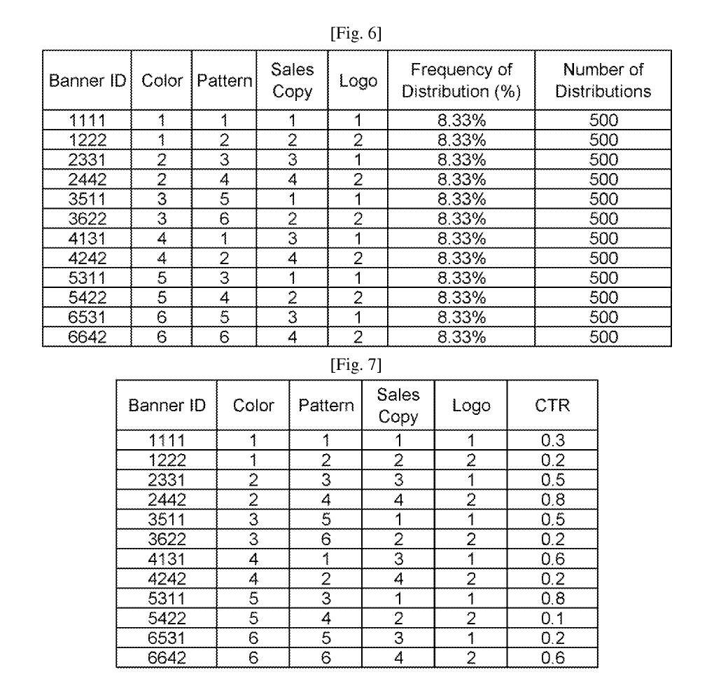

FIG. 6 illustrates an example of a list indicating distribution frequencies (referred to as “distribution frequency list” hereinafter) of the first distribution term determined by determining unit 1325. As shown in FIG. 6, a number of appearances contained in the first distribution term is the least common multiple of the numbers of candidate attributes of each of the components. Moreover, as shown in FIG. 6, distribution frequencies in connection with each candidate attribute of each component, for example, a sum of distribution frequencies of the first candidate attribute “red” of the first component “color,” a sum of distribution frequencies of the second candidate attribute “blue” of the first component “color,” etc., are the same.

After determining unit 1325 determines the distribution frequencies of the first distribution term, at each time that receiving unit 1322 receives a request for a banner advertisement data set (step S02), generating unit 1321 selects one banner ID from among banner IDs indicated in the distribution frequency list in a random manner at a distribution frequency of the selected banner ID, and generates a banner advertisement data set indicating a banner advertisement image with an appearance having attributes identified by the selected banner ID (step S03). Transmitting unit 1323 transmits the banner advertisement data set generated by generating unit 1321 to terminal device 12 that sent the request (step S04). Steps S02 to S04 are repeatedly performed until a number of distributions of banner advertisement data sets reaches a predetermined total number of distributions in the first distribution term.

Instead of generating banner advertisement data sets (step S03) after receiving requests (step S02) as explained above, generating unit 1321 may generate banner advertisement data sets of the predetermined total number of distributions in the first distribution term in advance, in accordance with the distribution frequencies indicated in the distribution frequency list, and select one banner advertisement data set from among the generated banner advertisement data sets in a random manner to forward it to transmitting unit 1323.

Moreover, generating unit 1321 may generate one appearance of banner advertisement data set only once and store the banner advertisement data set in storing unit 1326, to be reused. In such a case, generating unit 1321 may also store counters corresponding to each of banner IDs indicated in the distribution frequency list in storing unit 1326, and set, for example, total numbers of each of appearances specified by the banner IDs to the counters as default values. Then, each time that a banner advertisement data set is distributed, generating unit 1321 may decrease the value of a counter corresponding to the banner ID of the distributed banner advertisement data set by “1” to manage the distribution frequency. In such a case, generating unit 1321 may select one banner ID from among banner IDs whose counters are more than “0” in a random manner, and if the banner advertisement data set identified by the selected banner ID is stored in storing unit 1326, generating unit 1321 may merely forward the banner advertisement data set to transmitting unit 1323, and otherwise, generating unit 1321 generates the banner advertisement data set and transmits it to transmitting unit 1323.

The rule for determining when distribution of banner advertisement data sets in one distribution term should not be limited to the rule explained above, namely when a number of distributed banner advertisement data sets reaches a predetermined number, distribution is completed. For example, second banner distribution server device 132 may judge that a distribution term ends when a predetermined time period passes from a starting time of the distribution term or when a predetermined number of notices of display are received, and stop distributing banner advertisement data sets.

In the present application, a “predetermined term” for distributing banner advertisement data sets means a term between a timing of starting distribution of banner advertisement data sets in the distribution term and a timing of ending distribution of banner advertisement data sets in the distribution term, and the length in time of the term is not necessarily fixed. For example, in a case where second banner distribution server device 132 stops distributing banner advertisement data sets in a distribution term when second banner distribution server device 132 distributes a predetermined number of banner advertisement data sets, the length in time of the term varies case by case.

When distribution of banner advertisement data sets in the first distribution term is completed, determining unit 1325 determines a baseline-CTR (step S05). “Baseline-CTR” is a CTR that functions as a threshold used for selecting appearances of banner advertisement images that are distributed in later distribution terms, i.e. appearances of banner advertisement images whose distribution frequencies are more than 0%. For example, a comparatively small value such as 0.01 is set as the default baseline-CTR, and the baseline-CTR is maintained or increased in each of the later distribution terms depending on an overall average CTR in the previous distribution term.

When the baseline-CTR of the second distribution term is determined (step S05), if an overall average CTR of the first distribution term exceeds the baseline-CTR of the first distribution term, the overall average CTR of the first distribution term is set as the baseline-CTR of the second distribution term, and otherwise, the baseline-CTR of the first distribution term is maintained and used as the baseline-CTR of the second distribution term.

In step S05, a level of baseline-CTR is also set. The level of baseline-CTR is a number indicating how many times the baseline-CTR is changed. “1” is set as the default value of the level of baseline-CTR, and it is increased by “1” each time the baseline-CTR is changed. For example, if it is judged that an overall average CTR of the first distribution term is larger than the default baseline-CTR in step S05 for the second distribution term and the baseline-CTR is changed, the level of baseline-CTR is increased to “2.” On the other hand, if the overall average CTR of the first distribution term is equal to or lower than the default baseline-CTR and the baseline-CTR is not changed, the level of baseline-CTR is maintained as “1.”

When the baseline-CTR is changed or the level of baseline-CTR is changed, the new baseline-CTR or the new level of baseline-CTR is stored in storing unit 1326 without the old baseline-CTR or the old level of baseline-CTR being deleted. For example, if the baseline-CTR was changed twice, the current level of baseline-CTR is 3. In such a case, the baseline-CTR of level 1 and the baseline-CTR of level 2 are also stored in storing unit 1326 as well as the current baseline-CTR of level 3. These baseline-CTRs of each of levels 1 to 3 are used for determining numbers of banner advertisement data sets of each of appearances (step S15) in the next distribution term.

Next, determining unit 1325 selects appearances of banner advertisement images whose CTRs in the first distribution term are equal to or greater than the baseline-CTR from among the appearances of banner advertisement images that were distributed in the first distribution term, and determines the selected appearances of banner advertisement images as the appearances that will be continuously distributed in the second distribution term (step S06).

In step S06, a level is set to each of the appearances of banner advertisement images that are to be continuously distributed in the second distribution term. A level of appearance of banner advertisement images is used for determining a number of banner advertisement data sets to be distributed in the distribution term. For example, if the current level of baseline-CTR is “1,” in connection with all of the appearances of banner advertisement images that are continuously distributed in the second distribution term, “1” is set as the level of appearance. On the other hand, if the current baseline-CTR is “2,” namely, if the baseline-CTR is changed in step S05, in connection with appearances of banner advertisement images whose CTRs in the first distribution term are equal to or more than the baseline-CTR, “2” is set as the level of appearance, and in connection with the other appearances, “1” is set as the level of appearance.

Next, determining unit 1325 multiplies, in connection with each of the appearances of banner advertisement images that will be continuously distributed in the second distribution term, a “least required impression number” by the level of appearance plus “1,” i.e, (least required impression number)*(level+1), for calculating a number of banner advertisement image sets to be distributed in the second distribution term (step S07). The “least required impression number” is a number of impressions of a banner advertisement image that is estimated to be necessary to generate a predetermined required number of clicks on the banner advertisement image. For example, when the required number of clicks is set at “5” and CTR is estimated “0.01,” the least required impression number is 500 (5*0.01=500). In such a case, in connection with an appearance of a banner advertisement image whose level of appearance in the second distribution term is “2,” 500*(2+1)=1,500 is calculated as a number of times of distribution of the appearance of the banner advertisement image in the second distribution term.

Next, determining unit 1325 selects some appearances of banner advertisement images from among the appearances that were not distributed in the first distribution term as appearances to be distributed in the second distribution term (step S08). The appearances that were not distributed in the most recent distribution term and will be distributed in the next distribution term are determined in accordance with an extraction logic using multivariable analysis.

In the following part, an example of the extraction logic is explained. First, determining unit 1325 selects, from among all term-CTRs of appearances calculated in the most recent distribution term, term-CTRs in a range between, for example, the overall average CTR minus triple standard deviation and the overall average CTR plus triple standard deviation. This selection is performed for eliminating term-CTRs that may be outliers for the subsequent statistical analysis.

FIG. 7 illustrates a sample of list indicting term-CTRs of appearances of banner advertisement images after the selection of term-CTRs for eliminating outliers (referred to as “distribution result list” hereinafter). Since the sample shown in FIG. 7 is a distribution result list in connection with the first distribution term, the appearances of banner advertisement image indicated in the list are identical to those indicated in the list shown in FIG. 6. However, appearances of banner advertisement images indicated in distribution result lists in connection with the second and the later distribution terms may change.

Next, determining unit 1325 calculates an average CTR in connection with each attribute of each component as a weight for the attribute of the component. FIG. 8 illustrates a sample of list indicating weights calculated as explained above.

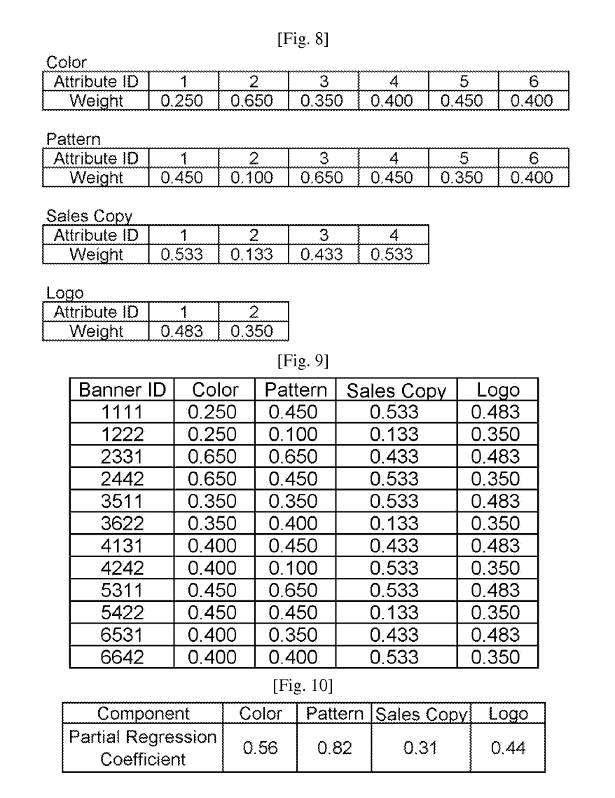

Next, determining unit 1325 generates a list indicating weights assigned to each component of each appearance of banner advertisement image that was distributed in the most recent distribution term. Since the list indicates indexes of advertising efficiency in connection with each component of each appearance, the list is referred to as an “efficiency report list” hereinafter. FIG. 9 is a sample of an efficiency report list.

Next, determining unit 1325 calculates partial regression coefficients by multiple regression analysis using the weights indicated in the efficiency report list as explanatory variables and CTRs indicated in the distribution result list shown in FIG. 7 as objective variables. FIG. 10 illustrates samples of partial regression coefficients calculated by the above-explained multiple regression analysis. When any calculated partial regression coefficient becomes minus, the multiple regression analysis is repeated without the component whose partial regression coefficient becomes minus. When a determination coefficient becomes less than a predetermined threshold such as 0.5, determining unit 1325 does not perform the subsequent processes for estimating CTRs by use of the calculated partial regression coefficients, and determines estimated CTRs following another rule such as (1) to select appearances of banner advertisement images by estimating CTRs assuming that all of partial regression coefficients are “1,” and (2) to select appearances of banner advertisement images in a random manner.

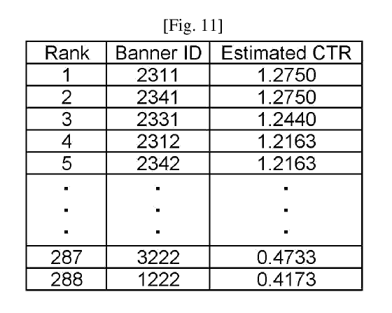

Next, determining unit 1325 calculates an estimated CTR of each of appearances of banner advertisement images by multiplying the weight indicated in the list shown in FIG. 8 by the partial regression coefficient shown in FIG. 10 in connection with each of components, and summing the results of the multiplications. Then, determining unit 1325 generates a list indicating appearances of banner advertisement images identified by banner IDs in descending order of the estimated CTRs (referred to as a “ranking list” hereinafter). FIG. 11 illustrates a sample of a ranking list generated by determining unit 1325.

Next, determining unit 1325 selects appearances of banner advertisement images from the top to bottom of the ranking list without selecting appearances that were distributed in the most recent distribution term and will be continuously distributed in the next distribution term until the total number of selected appearances reaches a “reshuffle number.” A “reshuffle number” is a number of appearances that was not distributed in the previous distribution term and will be newly distributed in the next distribution term. Determining unit 1325 subtracts a sum of numbers of impressions (distributions) of appearances of banner advertisement images that will be continuously distributed in the next distribution term from a predetermined number of total impressions to make a number of impressions for reshuffled appearances, and divides the number of impressions for reshuffled appearances by the least required impression number to make a reshuffle number.

For example, when the number of total impressions is 10,000, the sum of numbers of impressions (distributions) of appearances that will be continuously distributed is 7,000, and the least required impression number is 500, the reshuffle number becomes (10,000−7,000)/500=6. In such a case, determining unit 1325 selects the top six appearances in the ranking list without selecting appearances that will be continuously distributed as newly selected appearances of banner advertisement images that will be distributed in the next distribution term.

This is an explanation of an example of extraction logic for selecting appearances of banner advertisement image that were not distributed in the most recent distribution term and will be distributed in the next term.

Now, explanation of a flow of processes for determining distribution frequencies of banner advertisement data sets illustrated in FIG. 5 is continued. Determining unit 1325 determines the least required impression number as a number of distributions (impressions) of each of the appearances of banner advertisement images selected in accordance with the above-explained extraction logic (step S09).

After numbers of distributions, in other words distribution frequencies, of each of appearances of banner advertisement images that will be distributed in the second distribution term are determined as explained above, the generation of banner advertisement data sets by determining unit 1325 in accordance with the determined number of distributions (or distribution frequencies) in step S11 that is triggered by the reception of a request for banner advertisement data set by receiving unit 1322 in step 10, and the transmission of the generated banner advertisement data set by transmitting unit 1323 in step S12 is repeatedly performed until the second distribution term ends.

Next, determining unit 1325 determines the baseline-CTR for the third distribution term (step S13). In the step for determining the baseline-CTR for the third and the later distribution terms, if a total average CTR of the most recent distribution term exceeds the current baseline-CTR, the total average CTR of the most recent distribution term is set as the new baseline-CTR for the next distribution term, and otherwise, the current baseline-CTR is maintained and continuously used as the baseline-CTR for the next distribution term. When the baseline-CTR is changed, in the same way as in step S05, the level of baseline-CTR is increased by “1.”

Next, determining unit 1325 selects appearances of banner advertisement images whose CTRs in the second distribution term are equal to or greater than the current baseline-CTR from among the appearances of banner advertisement image that were distributed in the second distribution term, and determines the selected appearances of banner advertisement images as the appearances that will be continuously distributed in the third distribution term (step S14).

In step S14, a level of appearance is set to each of the appearances of banner advertisement images that are determined to be continuously distributed in the third distribution term. The setting of level of appearance for the third and the later distribution terms is, for example, performed as explained below.

It is assumed that the current level of baseline-CTR is A.

(1) Determining unit 1325 sets a level of appearance (A+1) to appearances whose all-term-CTRs are equal to or greater than the baseline-CTR of level A (the current baseline-CTR), and whose term-CTRs of the most recent distribution term are equal to or greater than the baseline-CTR of level A.

(2) Determining unit 1325 sets a level of appearance A to appearances whose all-term-CTRs are equal to or greater than the baseline-CTR of level A (the current baseline-CTR), and whose term-CTRs of the most recent distribution term are less than the baseline-CTR of level A.

(3) Determining unit 1325 sets a level of appearance A to appearances whose all-term-CTRs are less than the baseline-CTR of level A (the current baseline-CTR) but equal to or greater than the baseline-CTR of level (A−1), and whose term-CTRs of the most recent distribution term are equal to or greater than the baseline-CTR of level (A−1).

(4) Determining unit 1325 sets a level of appearance (A−1) to appearances whose all-term-CTRs are less than the baseline-CTR of level A (the current baseline-CTR) but equal to or greater than the baseline-CTR of level (A−1), and whose term-CTRs of the most recent distribution term are less than the baseline-CTR of level (A−1).

(5) Determining unit 1325 sets levels of appearance to the other appearances in accordance with rules (3) and (4) by replacing A with (A−1), A with (A−2), or the like.

Next, processes that are similar to the processes in steps S07 to S12 for the second distribution term are performed for the third distribution term as steps S15 to S20.

Then, the processes in steps S13 to S20 are repeatedly performed for the fourth distribution term and the later distribution terms.

This is an explanation of exemplary flow of processes performed by second banner distribution server device 132 to determine distribution frequencies of banner advertisement data sets.

As explained above, according to banner distribution system 1, indexes such as CTRs that indicate current efficiencies of banner advertisement images that were not distributed in the past are estimated based on indexes such as CTRs that indicate efficiencies in the past of banner advertisement images that were distributed in the past, and banner advertisement data sets that are estimated to bring high advertising efficiency are selected as banner advertisement data sets that will be distributed in the future based on the estimated indexes. Accordingly, even if advertising efficiency of each of banner advertisement data sets may change as time passes, advertising efficiency of a total of the distributed banner advertisement images is always kept high.

Moreover, according to banner distribution system 1, each of appearances of a banner advertisement image is automatically determined by second banner distribution server device 132 in accordance with indexes of attributes of components. Accordingly, for example, a designer is not required to design manually each of the appearances but is only required to set attributes of each component of banner advertisement image to second banner distribution server device 132. Therefore, time and effort required for the designer and costs required for achieving the advertising efficiency are decreased.

### (Modification)

The above-explained exemplary embodiment may be variously modified within the technical thought of the present invention. In the following, some of the modifications are described.

### (First Modification)

When determining unit 1325 determines distribution frequencies of each of banner advertisement data sets, segmentations may be performed by determining unit 1325. Some examples of such segmentations are explained below.

(1) Determining unit 1325 may segment a time band such as one day into plural sub time bands such as morning, daytime and nighttime, and determine distribution frequencies of each of banner advertisement data sets in each of sub time bands based on numbers of notices of display, notices of clicks and notices of order in each of the sub time bands. The plural sub time bands and their lengths may be determined by any way. For example, one week may be segmented into days of a week, and one year may be segmented into months of a year.

To achieve the above mentioned aspect (1), second banner distribution server device 132 records time data sets indicating times when each of notices of display, notices of clicks and notices of order were received together with banner IDs contained in the notices as log data sets. Determining unit 1325 separates log data sets into groups that correspond to the sub time bands based on time data sets in the log data sets, and performs the same processes for determining distribution frequencies as in the above-explained exemplary embodiment in connection with each of the groups.

According to the above mentioned aspect (1), a banner advertisement data set distributed to terminal device 12 is selected by second banner distribution server device 132 depending on timing of reception of a request for a banner advertisement data set from terminal device 12.

(2) Determining unit 1325 may segment a certain area (geographic area) into plural sub areas, and determine distribution frequencies of each of banner advertisement data sets that are distributed to terminal devices 12 located in each of sub areas based on numbers of notices of display, notices of clicks and notices of order received from terminal devices 12 located in each of the sub areas. The plural sub areas and their sizes may be determined in any way. For example, the entire world may be segmented into two sub areas such as a domestic area and a foreign area, and Japan may be segmented into sub areas such as north Japan and south Japan, or into prefectures.

To achieve the above-mentioned aspect (2), second banner distribution server device 132 obtains, for example, IP addresses of terminal devices 12 when second banner distribution server device 132 receives notices of display, notices of clicks or notices of order from terminal devices 12, and obtains area data sets indicating sub areas where the IP addresses, i.e. terminal devices 12, are located by requesting them from an external server device. Then, second banner distribution server device 132 records the area data sets together with banner IDs contained in the notices as log data sets. Determining unit 1325 separates log data sets into groups that correspond to the sub areas based on area data sets in the log data sets, and performs the same processes for determining distribution frequencies as in the above-explained exemplary embodiment in connection with each of the groups.

According to the above-mentioned aspect (2), terminal device 12 transmits its IP address to second banner distribution server device 132 together with a request for a banner advertisement data set. Second banner distribution server device 132 specifies an area where terminal device 12 is located based on the received IP address, and selects a banner advertisement data set that is distributed to terminal device 12 in accordance with the specified area.

According to the above-mentioned aspect (2), if terminal device 12 is a mobile terminal device and wirelessly communicates with other devices, an area ID of a base station that terminal device 12 accesses may be used for specifying the area where terminal device 12 is located, instead of an IP address. If terminal device 12 has a GPS (Global Positioning System) for specifying a position where terminal device 12 is located, a position data set indicating, for example, coordinates that are generated by the GPS may be used instead of an IP address.

(3) Determining unit 1325 may separate terminal devices 12 into plural groups depending on their display attributes such as numbers of pixels of displays, abilities for processing motion images, background colors of browsers, whether the device is mobile device, etc., and determines distribution frequencies of each of banner advertisement data sets that are distributed to terminal devices 12 belonging to each of the groups based on numbers of notices of display, notices of clicks and notices of order received from terminal devices 12 belonging to each of the groups. Any sort of display attribute that can be transmitted from terminal device 12 to second banner distribution server device 132 such as a display attribute that a browser obtains from OS or the like at terminal device 12 may be used for the grouping.

To achieve the above-mentioned aspect (3), second banner distribution server device 132 obtains, for example, display attribute data sets indicating display attributes of terminal devices 12 when second banner distribution server device 132 receives notices of display, notices of clicks or notices of order from terminal devices 12, and records the display attribute data sets together with banner IDs contained in the notices as log data sets. Determining unit 1325 separates log data sets into groups depending on display attribute data sets in the log data sets, and performs the same processes for determining distribution frequencies as in the above-explained exemplary embodiment in connection with each of the groups.

For example, numbers of pixel of display and ability for processing motion images may be obtained from OS of terminal device 12, and background color of browser may be obtained from descriptions of CSS (Cascading Style Sheets) in a web page data set. The information on whether terminal device 12 is a mobile terminal device may be specified by second banner distribution server device 132 by making terminal device 12 transmit an ID of a carrier that terminal device 12 uses for wireless communication to second banner distribution server device 132, if terminal device 12 is a mobile terminal device.

According to the above-mentioned aspect (3), terminal device 12 transmits display attribute data set indicating its display attributes to second banner distribution server device 132 together with a request for banner advertisement data set. Second banner distribution server device 132 specifies a group that terminal device 12 belongs to based on the received display attribute data set, and selects a banner advertisement data set that is distributed to terminal device 12 in accordance with the specified group of display attributes.

Determining unit 1325 may separate users of terminal devices 12 into plural groups depending on their user attributes such as gender, age group, tastes, etc., and determines distribution frequencies of each of banner advertisement data sets that are distributed to terminal devices 12 whose users belong to each of the groups, based on numbers of notices of display, notices of clicks and notices of order received from terminal devices 12 whose users belong to each of the groups.

For achieving the above-mentioned aspect (4), each of terminal devices 12 records data sets input by their users such as data sets indicating answers to questionnaires that users input in web pages distributed from web server devices 11 in banner distribution system 1, and data sets indicating keywords that users input in browsers for searching the web pages. The data sets indicate answers to questionnaires may be recorded in terminal devices 12 by using, for example, cookie technology. The data sets indicating search keywords may be obtained by terminal devices 12 from the web pages as referrer data sets, and recorded in terminal devices 12 by using, for example, cookie technology. When second banner distribution server device 132 receives notices of display, notices of click and notices of order, second banner distribution server device 132 also receives user attribute data sets that are recorded in terminal devices 12 as, for example, data sets of cookies, and records the user attribute data sets together with banner IDs contained in the notices as log data sets. Then, determining unit 1325 separates log data sets into groups depending on user attribute data sets in the log data sets, and performs the same processes for determining distribution frequencies as in the above-explained exemplary embodiment in connection with each of the groups.

According to the above-mentioned aspect (4), user attribute data sets may be recorded in second banner distribution server device 132 instead of in terminal devices 12 as data sets of cookies. In such a case, second banner distribution server device 132 may record user attribute data sets together with unique IDs identifying terminal devices 12 or browsers of terminal devices 12. If terminal device 12 is a mobile terminal device to which UIDs (User Identifiers) are assigned, the UIDs may be used as the unique IDs.

In such a case, when terminal devices 12 transmit notices such as notices of display to second banner distribution server device 132, terminal devices 12 also transmit data sets that were input by users in web pages and indicate user attributes such as gender, age group, tastes, etc., data sets that were obtained from web pages as referrers and indicate keywords input by users for searching the web pages, etc., or the like, to second banner distribution server device 132 as user attribute data sets. Second banner distribution server device 132 receives the user attribute data sets from terminal devices 12, and records the user attribute data sets together with unique IDs as log data sets.

Second banner distribution server device 132 integrates log data sets that contain a common unique ID, i.e. log data sets that were received from a common terminal device 12 (or a common browser), and separates the integrated log data sets into groups depending on user attribute data sets in the log data sets. Then, second banner distribution server device 132 performs the same processes for determining distribution frequencies as in the above-explained exemplary embodiment in connection with each of the groups.

According to the above mentioned aspect (4), terminal devices 12 transmit user attribute data sets to second banner distribution server device 132 together with requests for banner advertisement data sets. Second banner distribution server device 132 specifies which group each of users of terminal devices 12 belongs to based on the received user attribute data sets, selects banner advertisement data sets for the specified group, and distributes the selected banner advertisements to terminal devices 12.

According to the above mentioned aspect (4), second banner distribution server device 132 may distribute a predetermined banner advertisement data set preferentially to terminal devices 12 that have a predetermined user attribute.

For example, when second banner distribution server device 132 receives from terminal device 12 user attribute data sets indicating a search keyword “career change” that was input by a user of terminal device 12 in a search site or indicating that the user visited web sites for supporting visitors who wished to change their careers in the past, second banner distribution server device 132 may determine a predetermined banner advertisement data set that indicates a certain sales copy such as “Please feel free to contact ABC agent when you consider changing you career!” to be distributed to terminal device 12 does not determine a banner advertisement data set to be distributed to terminal device 12, instead of following the above explained extraction logic.

Alternatively, when second banner distribution server device 132 receives from terminal device 12 user attribute data sets indicating a search keyword “career change” that was input by a user of terminal device 12 in a search site or indicating that the user visited web sites for supporting visitors who wished to change their careers in the past, second banner distribution server device 132 may select a certain sales copy such as “Please feel free to contact ABC agent when you consider changing your career!” if the banner advertisement data set is included in the candidate banner advertisement data sets that may be distributed to terminal device 12 at a certain distribution frequency, and otherwise, second banner distribution server device 132 may select a banner advertisement data set in accordance with the extraction logic. Then, second banner distribution server device 132 may distribute the selected banner advertisement data set to terminal device 12.

### (Second Modification)

According to the above-explained embodiment, second banner distribution server device 132 uses CTRs for determining distribution frequencies of banner advertisement data sets. In this modification, second banner distribution server device 132 uses indexes indicating advertising efficiency other than CTRs such as CVRs, procedures of sale, etc., for determining the distribution frequencies. These indexes may be used by second banner distribution server device 132 together with CTRs.

Now, an example of flow of processes performed by second banner distribution server device 132 for determining distribution frequencies by use of numbers of CV (Conversion) and numbers of stays as well as CTRs is explained in the following part.

In this modification, distribution frequencies are determined based on four sorts of indexes, i.e. CTRs, numbers of direct CVs, numbers of indirect CVs and numbers of stays. Then, a ratio among the following four sorts of numbers is set to second banner distribution server device 132 in advance by a user, such as a user who manages second banner distribution server device 132.

(1) A number of banner advertisement data sets that are distributed at distribution frequencies determined based on CTRs in the same way as in the above-explained exemplary embodiment.

(2) A number of banner advertisement data sets that are distributed at distribution frequencies determined based on numbers of “direct” CVs.

(3) A number of banner advertisement data sets that are distributed at distribution frequencies determined based on numbers of “indirect” CVs.

(4) A number of banner advertisement data sets that are distributed at distribution frequencies determined based on numbers of stays.

A number of CVs is a number of particular operations such as clicks that are made by users of terminal devices 12 for opening a target web page directly or indirectly linked to a banner advertisement image, or for ordering goods or services in the target web page. When the particular operation was made in a web page that was displayed by terminal device 12 in accordance with a web page data set received from any one of web server devices 11 via a communication connection, such as a session, that was established in response to an operation performed on a banner advertisement image, the particular operation is counted as a “direct” CV.

On the other hand, when the particular operation was made in a web page that was displayed by terminal device 12 in accordance with a web page data set received from any one of web server devices 11 via a communication connection, such as a session, that was re-established after a communication connection, such as a session, established in response to an operation made to a banner advertisement image had been disconnected, the particular operation is counted as an “indirect” CV.

A number of stays is a number of web pages viewed by a user of terminal device 12 in one web site, i.e. a group of plural web pages mutually linked, that the user visited by performing a certain operation such as a click on a banner advertisement image displayed in terminal device 12. The web page that is directly linked to the banner advertisement image and viewed first in the web site by the user is referred to as the landing page, and a number of web pages other than the landing page in the web site that were viewed by the user are counted to obtain the number of stays.

In the following explanation, it is assumed that a number of banner advertisement data sets distributed in each distribution term is 1000, a ratio among numbers (1) to (4) is set 6:2:1:1, and numbers (2) to (4) are counted in the last seven days. Now, a series of processes performed by second banner distribution server device 132 for determining distribution frequencies of banner advertisement data sets is explained below.

When the first distribution term starts, numbers of direct CVs, indirect CVs and stays in the past are not available yet. Accordingly, all of the banner advertisement data sets distributed in the first distribution term, i.e. 1,000 banner advertisement data sets, are distributed by use of CTRs in the same way as in the above-explained exemplary embodiment, without attention to the ratio among numbers (1) to (4).

When the second distribution term or the later distribution terms start, in accordance with the ratio among numbers (1) to (4), 600 banner advertisement data sets are distributed by use of CTRs in the same way as in the above-explained exemplary embodiment. Among the remaining 400 banner advertisement data sets, 200 banner advertisement data sets are distributed at distribution frequencies (weights) determined based on scores (explained later) calculated by use of numbers of direct CVs counted in the previous seven days. Similarly, 100 banner advertisement data sets are distributed at distribution frequencies (weights) determined based on scores calculated by use of numbers of indirect CVs counted in the last seven days, and 100 banner advertisement data sets are distributed at distribution frequencies (weights) determined based on scores calculated by use of numbers of stays counted in the last seven days.

The ways for determining distribution frequencies (weights) based on scores calculated by use of numbers of direct CVs, indirect CVs and stays are same. Accordingly, only the way of using numbers of direct CVs is explained below.

It is assumed that a banner advertisement data set identified by banner ID i has attribute jn of the n-th component. In the following explanation, a banner advertisement data set identified by banner ID i is referred to as banner i. Determining unit 1325 calculates weights W(i) based on numbers of direct CVs counted in the previous seven days, in the following ways.

A number of direct CVs of banner i is expressed as CV(i).

A sum of numbers of direct CVs of banners that have attribute jn is expressed as CV(jn)=ΣCV(x). (“Σ” means a sum. “x” is any one of banner IDs of banners having attribute jn.)

A contribution of banner i in weight is expressed as W′(i)=CV(i)/ΣCV. (ΣCV is a sum of numbers of direct CVs of all of banners.)

A contribution of attribute jn in weight is expressed as W′ (jn)=CV(jn)/ΣCV.

A number of banners that have attribute jn is expressed as N(jn).

A weight assigned to banner i is expressed as W(i)=W′(i)+Σ(W′(jn)/N(jn))

Determining unit 1325 selects 200 banner advertisement data sets to be distributed to terminal devices 12 at distribution frequencies indicated by W(i) calculated as explained above.

In the same way, weights assigned to banner i are calculated by use of numbers of indirect CVs and 100 banner advertisement data sets are distributed at distribution frequencies indicated by the calculated weights. Moreover, in the same way, weights assigned to banner i are calculated by use of numbers of stays and 100 banner advertisement data sets are distributed at distribution frequencies indicated by the calculated weights.

In accordance with this modification, a user, such as a user who manages a web site, may adjust the ratio among the numbers of distributions of banner advertisement data set determined by each of plural indexes such as CTRs, numbers of direct CVs, numbers of indirect CVs and numbers of stays so that the total advertising efficiency is increased.

According to the above-explained modification, numbers of direct CVs, numbers of indirect CVs and numbers of stays are used for determining distribution frequencies of banner advertisement data sets in addition to CTRs. These indexes are examples that may be used in the modification, and any other indexes that indicate advertising efficiency such as CVRs, numbers of viewed pages, etc., may be used for determining distribution frequencies.

According to the above-explained modification, it is assumed that the ratio among numbers of distributions determined based on each of the indexes is manually set by a user who manages second banner distribution server device 132 in accordance with instructions input by a user who manages a web site, and the ratio is not changed. Alternatively, second banner distribution server device 132 may automatically adjust the ratio. In such a case, for example, a user sets target values of the indexes to second banner distribution server device 132, and second banner distribution server device 132 repeatedly changes the ratio by, for example, a predetermined amount in the direction to cause the indexes to come close to the target values, at each time when a new distribution term starts. As a result, distribution frequencies are determined based on the plural indexes in a balanced manner.

### (Other Modifications)

Banner distribution system 1 may comprise a single banner distribution server device that has both of the functions of first banner distribution server device 131 and second banner distribution server device 132 instead of banner distribution server devices 13.

Some processes performed by first banner distribution server device 131 in the above-explained exemplary embodiment may be performed by second banner distribution server device 132. Similarly, some processes performed by second banner distribution server device 132 in the above-explained exemplary embodiment may be performed by first banner distribution server device 131. For example, in banner distribution system 1, first banner distribution server device 131 forwards requests for banner advertisement data sets received from terminal devices 12 to second banner distribution server device 132. Instead of this configuration, first banner distribution server device 131 may receive a banner advertisement data set generated by second banner distribution server device 132 from second banner distribution server device 132, and transmit the received banner advertisement data set to terminal device 12 in response to the request. In another example, second banner distribution server device 132 may only determine distribution frequencies of banner advertisement data sets, and generation and distribution of banner advertisement data sets may be performed by first banner distribution server device 131. In the case, for example, that banner IDs identifying banner advertisement data sets to be distributed and numbers of distribution or distribution frequencies of each of the banner advertisement data sets are notified from second banner distribution server device 132 to first banner distribution server device 131.

Any one of first banner distribution server device 131 and second banner distribution server device 132 may be realized by a computer having a communication function by causing the computer to carry out data processing in accordance with instructions of an application program. Alternatively, any one of first banner distribution server device 131 and second banner distribution server device 132 may be a dedicated machine.

In the above-explained exemplary embodiment, second banner distribution server device 132 uses multiple regression analysis for determining distribution frequencies of banner advertisement data sets. Instead of multiple regression analysis, second banner distribution server device 132 may use other sorts of multivariable analysis than multiple regression analysis for determining distribution frequencies of banner advertisement data sets. Furthermore, second banner distribution server device 132 may determine distribution frequencies without using multiple regression analysis. For example, second banner distribution server device 132 may assign weights to CTRs so that the older a CTR is, the smaller a weight assigned to the CTR is, and generate a ranking list of banner advertisement images in decreasing order of weighted CTRs of the banner advertisement images. Then, second banner distribution server device 132 may assign distribution frequencies to each of the banner advertisement images depending on a position of the banner advertisement image in the ranking list.

In the above-explained exemplary embodiment, second banner distribution server device 132 does not distribute all possible appearances of banner advertisement images in the first distribution term, and selects appearances to be distributed in the first distribution term so that each attribute of each component is contained at an equal rate to the others in the selected appearances. Then, second banner distribution server device 132 estimates advertising efficiency of appearances that are not selected for distribution in the first distribution term based on indexes such as CTRs obtained in the first distribution term, and determines distribution frequencies of appearances of banner advertisement images that will be distributed in the second distribution term based on the estimated efficiencies. Alternatively, second banner distribution server device 132 may distribute all possible appearances in the first distribution term for obtaining indexes indicating advertising efficiency in connection with each of all of possible appearances, and determine distribution frequencies in the second distribution term based on the obtained indexes.

A server device and program according to the present invention are usable in service industry for distributing advertisements via networks such as Internet.

1-13. (canceled)

14. A server device comprising:
a generating unit that selects, in connection with each of plural components of an advertisement image, one attribute from among plural candidate attributes of the component in accordance with a predetermined rule, and generates an image data set indicating an advertisement image composed of plural components each of which has the selected attribute;
a receiving unit that receives a request for an image data set from any terminal device;
a transmitting unit that transmits an image data set generated by the generating unit in response to the request; and
a timing unit;
wherein
the receiving unit receives a notice of display that indicates which image data set among plural image data sets generated by the generating unit and transmitted by the transmitting unit was used for displaying an advertisement image at any terminal device;
the receiving unit receives a notice of advertisement operation that indicates which image data set among plural image data sets generated by the generating unit and transmitted by the transmitting unit was used for displaying an advertisement data set on which a particular operation was performed by a user of the terminal device;
the service device further comprises:
a determining unit that repeatedly determines as time passes, in connection with each of plural image data sets indicating advertisement images that are different from each other, a frequency of transmission of the image data set transmitted to terminal devices by the transmitting unit during a predetermined period in the future, based on a number of display times that indicates a number of times of display of an advertisement image made by terminal devices using the image data set during a predetermined period in the past, the number of display times being determined by counting notices of display received by the receiving unit in the predetermined period in the past, and based on a number of advertisement operation times that indicates a total number of times a particular operation is performed by users of terminal devices on advertisement images indicated by the image data set during the predetermined period in the past, the number of advertisement operation times being determined by counting notices of advertisement operation received by the receiving unit in the predetermined period in the past.

15. A server device according to claim 14, wherein:
the determining unit calculates, in connection with each of plural image data sets including image data sets that can be generated by the generating unit and that were not transmitted by the transmitting unit in a predetermined period in the past, an estimated ratio of a number of times of the particular operation performed on advertisement images indicated by the image data set at terminal devices to a number of times of display of advertisement images made at terminal devices using the image data set, based on the number of display times and the number of advertisement operation times, and determines a frequency of transmission in connection with the image data set based on the estimated ratio calculated in connection with the image data set.

16. A server device according to claim 15, wherein:
the determining unit determines, in connection with each of plural components that may compose an advertisement image, a number of component display times that indicates a number of times of display of advertisement images composed of the component at terminal devices based on notices of display received by the receiving unit;
the determining unit determines, in connection with each of plural components that may compose an advertisement image, a number of component operation times that indicates a number of times the particular operation was performed by users of arbitrary terminal devices on advertisement images composed of the component at terminal devices based on notices of advertisement operation received by the receiving unit; and
the determining unit calculates the estimated ratio by conducting multivariate analysis in which the numbers of component display times determined in connection with the plural components and the numbers of component operation times determined in connection with the plural components are used as explanatory variables.

17. A server device according to claim 14, wherein:
the number of display times in connection with each of the plural image data sets indicates, in connection with each of plural time zones, a number of times of display of advertisement images indicated by the image data set at terminal devices in the time zone;
the number of advertisement operation times in connection with each of the plural image data sets indicates, in connection with each of the plural time zones, a number of times the particular operation was performed by users of arbitrary terminal devices on advertisement images indicated by the image data set in the time zone; and
the determining unit determines, in connection with each of combinations of the plural image data sets and the plural time zones, a frequency of transmission of the image data set to terminal devices in the time zone.

18. A server device according to claim 14, wherein:
the display number of times in connection with each of the plural image data sets indicates, in connection with each of plural areas, a number of times of display of advertisement images indicated by the image data set at terminal devices in the area;
the number of advertisement operation times in connection with each of the plural image data sets indicates, in connection with each of the plural areas, a number of times the particular operation was performed by users of terminal devices on advertisement images indicated by the image data set in the area;
the receiving unit receives an area data set that indicates an area where a terminal device from which the request is transmitted is located; and
the determining unit determines, in connection with each of combinations of the plural image data sets and the plural areas, a frequency of transmission of the image data set to terminal devices in the area.

19. A server device according to claim 14, wherein:
the number of display times in connection with each of the plural image data sets indicates, in connection with each of plural display attributes that a terminal device may have, a number of times of display of advertisement images indicated by the image data set at terminal devices that have the display attribute;
the number of advertisement operation times in connection with each of the plural image data sets indicates, in connection with each of the plural display attributes, a total number of times that the particular operation was performed by users of arbitrary terminal devices that have the display attribute;
the receiving unit receives a display attribute data set that indicates a display attribute that a terminal device from which the request is transmitted has; and
the determining unit determines, in connection with each of combinations of the plural image data sets and the plural display attributes, a frequency of transmission of the image data set to terminal devices that have the display attribute.

20. A server device according to claim 14, wherein:
the number of display times in connection with each of the plural image data sets indicates, in connection with each of plural user attributes that a user of a terminal device may have, a number of times of display of advertisement images indicated by the image data set at terminal devices used by users who have the user attribute;
the number of advertisement operation times in connection with each of the plural image data sets indicates, in connection with each of the plural user attributes, a number of times the particular operation was performed by users of terminal devices who have the user attribute;
the receiving unit receives a user attribute data set that indicates a user attribute that a user of a terminal device from which the request is transmitted has; and
the determining unit determines, in connection with each of combinations of the plural image data sets and the plural user attributes, a frequency of transmission of the image data set to terminal devices used by users who have the user attribute.

21. A server device according to claim 14, wherein:
the generating unit generates image data sets that are to be transmitted by the transmitting unit in response to a request for an image data set received by the receiving unit at a frequency determined by the determining unit

22. A server device according to claim 14 further comprising:
a first server device and a second server device that can communicate with each other via one or more networks;
wherein
the function of receiving a request for an image data set from an arbitrary terminal device of the receiving unit is allocated to the first server device; and
the functions of the determining unit are allocated to the second server device.

23. A server device according to claim 14, wherein:
the receiving unit receives a notice of page operation that indicates that a particular operation was performed by a user of an arbitrary terminal device on a web page displayed at the terminal device, the web page being displayed in accordance with a web page data set that the terminal device received from a web server device via a connection established between the server device and the terminal device, the web server transmitting the web page data set to the terminal device in response to a particular operation performed on an advertisement image displayed at the terminal device, the web page data set giving instructions to display the web page; and
the determining unit determines, in connection with each of plural image data sets that indicate advertisement images different from each other, the frequency at which the image data set should be transmitted to terminal devices by the transmitting unit in a predetermined period in the future, based on number of a page operation times that indicates a number of times a particular operation was performed by users of terminal devices on a web page linked to an advertisement image indicated by the image data set during a predetermined period in the past, the number of page operation times being determined by counting notices of page operation received by the receiving unit in the predetermined period in the past.

24. A server device according to claim 23, wherein:
the determining unit determines the frequency so that a ratio of a sum of frequencies determined based on the number of display times and the number of advertisement operation times to a sum of frequencies determined based on the number of page operation times becomes a predetermined ratio.

25. A server device according to claim 22, wherein:
the number of page operation times indicates, in connection with each of plural types of operations, a number of times the type of operation was performed by users of terminal devices; and
the determining unit determines the frequency so that a ratio of a sum of frequencies determined based on the number of times one of the plural types of operations was performed to a sum of frequencies determined based on the number of times another of the plural sorts of operations was performed becomes a predetermined ratio.

26. A program that instructs a computer having a communicating unit that communicates with a terminal device and a timing unit to function as the generating unit, the receiving unit, the transmitting unit and the determining unit that compose a server device according to claim 14.
